(19) United States
(12) Patent Application Publication
(10) Pub. No.: US 2013/0254394 A1
(43) Pub. Date: Sep. 26, 2013

(54) SHARED TERMINAL IDENTIFICATION SYSTEM USING A NETWORK PACKET AND PROCESSING METHOD THEREOF

(71) Applicants: Kyoung-Pil Kong, Kangnam-gu (KR); Yun-Seok Lee, Kangnam-gu (KR); Sun Min Jeon, Kangnam-gu (KR)

(72) Inventors: Kyoung-Pil Kong, Kangnam-gu (KR); Yun-Seok Lee, Kangnam-gu (KR); Sun Min Jeon, Kangnam-gu (KR)

(73) Assignee: PLUSTECH INC., Kangnam-gu, Seoul (KR)

(21) Appl. No.: 13/992,631

(22) PCT Filed: Dec. 5, 2011
(86) PCT No.: PCT/KR2011/009351

§ 371 Date: Jun. 7, 2013

(30) Foreign Application Priority Data
Dec. 7, 2010 (KR) 10-2010-0124205

(51) Int. Cl. H04L 12/26

(52) U.S. Cl. CPC H04L 43/10
USPC 709/224

(57) ABSTRACT

The present invention relates to a system and method for authenticating, monitoring, and managing all terminals connected to a wireless/wired network to use Internet. A shared terminal management system comprises a management server, a charging server, a central server, a central authentication G/W server, and a proxy server, and assigns a terminal identification value for every terminal that uses Internet, authenticates terminals by reading and analyzing the assigned terminal identification value, monitors and manages shared terminals used as being connected to one line to classify lines into a basic line and an additional line, and charges for the additional line. The shared terminal identification system for identifying and managing terminals connected to one Internet line comprises a subscriber line authentication unit, a packet collecting unit, a first packet analyzing unit, an element packet transmission unit, a data management unit and a terminal determining unit. The shared terminal processing method for managing the shared terminals comprises the following steps: detecting users of a sharing device; selecting target users for sharing devices; transmitting a notification; applying for an additional terminal service subscription; and ceasing the connection to the Internet.

### TECHNICAL FIELD

The present invention relates to a system and method for identifying, monitoring, and managing all terminals connected to a wireless/wired network to use Internet to assign a terminal identification value for every terminal that uses Internet, authenticate terminals by reading and analyzing the assigned terminal identification value, monitor and manage shared terminals used as being connected to one line.

The present invention relates to a shared terminal management system comprising a management server, an accounting server, a central server, a central authentication gateway (G/W) server, and a proxy server, to classify lines into a basic line and an additional line, and charges for the additional line and a processing method thereof, by using a terminal identification technology of inserting a terminal identification value for each terminal into a registry value or a setting file of an operating system (OS) or a cookie value which are referred by a web browser, and extracting and analyzing the terminal identification value of an HyperText Transfer Protocol (HTTP) header so that the terminal identification value may be included in a cookie of the HTTP header when a terminal connected to Internet accesses Internet.

### BACKGROUND ART

Owing to a recently rapid development and popularity of Internet technology, Internet has been easily used by anyone at present so that Internet user population has explosively increased, and Internet access methods and ways to use a network tend to have been complicated and diverse.

In a current price system in which it currently costs about 30,000 won to connect one floating public IP (Internet IP) address for Internet access, and it additionally costs more than 10,000 won for additional IP, it is uneconomical to assign a plurality of public IP addresses to a plurality of hosts, and there is a difficulty in failing to solve a depletion and shortage of limited IP addresses.

Therefore, to solve these problems, there have been recently many cases in which a network sharing device such as an IP sharer is used to form a network address translation (NAT) at one public IP such that a plurality of client subscribers concurrently use a network. Such sharing formation or system is frequently used in a normal environment using network sharing as well as companies.

However, network traffic overload and hacking, virus, or worm having a malicious object due to an increase in thoughtless network sharing become problems, which make it difficult to grasp a line availability status and sharing rate of a service provider and cause economical loss such as new facility expansion cost due to an increase in the corresponding network traffic, investment loss, and maintenance cost, and thus a problem in that line availability right is not uniformly provided to subscribers occurs.

Accordingly, to track a user who incurs the problem of the thoughtless network sharing, although it is important to settle expense loss by obtaining an actual IP address of the user, catching and analyzing the number of clients actually available for each line, establishing a management policy such as a selective allowance or shutoff with respect to the corresponding line, and separately charging loss expenses due to the traffic overload, no practical and detailed solution or method has not yet been proposed.

### DETAILED DESCRIPTION OF THE INVENTION

### Technical Problem

The present invention provides performing selective allowance and cut-off operations when private IP users concurrently access Internet by analyzing mirrored traffic in an environment in which the corresponding traffic can be monitored when clients use Internet, determining whether the clients use the NAT of a private network other than an assigned public IP, and analyzing and detecting the number of sharing clients, generating a database, and establishing a policy based on information included in the database, to obtain the number of clients actually available for each line, by using a method of determining whether a network address translation (NAT) is available and analyzing and detecting the number of sharing clients by analyzing traffic.

The present invention also provides, based on a value such as an average number of the shared terminals or the maximum shared terminal number that is detected through the above-described analysis and detection of the sharing number with respect to a predetermined time, selecting sharing targets, transmitting three step notices such as promotion, sanction, and cut-off to the selected sharing targets, inducing an additional terminal service subscription from the selected sharing targets, and, when the corresponding sharing targets reject the additional terminal service subscription, cutting off an Internet to sharing terminals.

### Technical Solution

The present invention provides a terminal management system that authenticates a terminal and provides an Internet access to a basic line and an additional line, the management including a management server, an accounting server, a central server, a central authentication G/W server, and a proxy server, charging with respect to the additional line, wherein the additional line detect terminals other than a basic terminal from a plurality of connected terminals by using a method of using a sharer, a method of connecting the sharer and a hub, a connection method using a VPN equipment including a sharing function, or a method of using a VPN dedicated equipment.

According to an aspect of the present invention, there is provided a shared terminal identification system for identifying and managing terminals sharing a single Internet line in a network environment in which traffic of all subscribers connected to a wideband network and using Internet is monitored and analyzed, the shared terminal identification system including: a management server for analyzing the traffic of the subscribers and detecting sharer users; an accounting server for identifying the sharer users and determining a number of terminals using a sharer; a central server for providing marketing data; a central authentication G/W server for managing and linking to authentication information; and a proxy server for managing and linking to a customer DB, wherein the management server for detecting the sharer user includes: a subscriber line authentication unit for identifying all subscribers using Internet; a packet collection unit for detecting an HTTP GET packet; a first packet analyzing unit for analyzing a header of the HTTP GET packet requesting a web page; an identification packet transmission unit for generating and transmitting a response packet in response to the HTTP GET packet requesting the web page so as to insert an identification value into the terminal; a second packet analyzing unit for analyzing a GET packet requesting an element of the web page; an element packet transmission unit for generating and transmitting a response packet in response to the GET packet requesting the element of the web page so as to request a specific element; a data management unit for managing subscriber authentication data and the entire data including an IP and URL and the terminal identification value so as to analyze, identify, and manage terminals; and a terminal determination unit for determining the terminals used by connecting several terminals to the single line and a number of the terminals.

The subscriber line authentication unit collects and manages IP-ID, IP-Mac, and IP-CMMAc in the central authentication G/W server by linking to a unified authentication system that manages IP-ID and IP-Mac information indicating a person of a corresponding IP in real time with respect to a network subscriber of an authentication section, collects and manages IP-Mac and Port-Mac in an equipment name-Mac format in the central authentication G/W server by periodically collecting IP-Mac and Port-Mac managed by specific equipment such as a router, a switch, L3, L2, and a DHCP to use IP-Mac and Port-Mac as authentication data with respect to a network subscriber of a non-authentication section, classifies the authentication data stored in the authentication G/W server into IP bandwidths, identifies the authentication data in an environment in which traffic of a specific terminal is mirrored to the management server in which a corresponding backbone network is installed, and transmits the authentication data to an authentication processing engine of the corresponding management server, manages the received authentication data in memory managed by the authentication processing engine of the corresponding management server in real time, when the corresponding traffic comes in, prepares to respond to the authentication data in real time, analyzes a user packet of the mirrored traffic, extracts an IP, and authenticates the IP in real time by utilizing the authentication data of the authentication processing engine of the corresponding management server.

The packet collection unit collects the GET packet necessary for analysis from among the monitored entire traffic.

The first packet analyzing unit that is a section for analyzing the header of the HTTP GET packet requesting the web page a) compares and analyzes authentication information of the subscriber line authentication unit regarding the collected GET packets and data managed by the data management unit, determines whether a corresponding terminal is a terminal into which the terminal identification value is previously inserted, and allows the identification packet transmission unit to insert the terminal identification value into the corresponding terminal according to a result of determination, and b) extracts headers of the collected GET packets collected by the packet collection unit, analyzes the terminal identification value, ends the processing operation according to a result of analysis, and allows the second packet analyzing unit for analyzing the GET packet to process a request for the element of the web page requested by the terminal.

The identification packet transmission unit that is a section for generating and transmitting the response packet in response to the HTTP GET packet so as to insert the identification value into the terminal uses a transmission method including: a) inserting the terminal identification value into a cookie of a packet header to be generated and inserting a phrase generated in a client script and HTML interpretable by a web browser into a packet body to cause the corresponding terminal to be requested again to a designation address (destination IP or URL) that is an original request target; b), unlike operation a), inserting a phrase generated by a language interpretable by the web browser into the packet body so as to call a URL of the generated web page to cause the terminal identification value to be inserted into the cookie by a client script or a server script; c) transmitting a response packet generated through operation a) or b) to the corresponding terminal; d) adding authentication information regarding the corresponding terminal and information for managing the terminal identification value to the data managed by the data management unit so as to manage the corresponding terminal; and e) analyzing the packet by using the web browser of the terminal that receives the response packet, inserting the terminal identification value into a location in which cookie information of an OS referred to by the web browser is stored, requesting a web page for a server that is an original request target again or after accessing the URL of the generated web page of operation b), inserting the terminal identification value into the cookie.

The data management unit manages the authentication data, IP and URL information regarding an original request destination server or a specific web page address, and the terminal identification value in a single set.

The second packet analyzing unit that is a section for analyzing the GET packet requesting the element of the web page a) analyzes whether the corresponding terminal is the terminal analyzed by the first packet analyzing unit, b) analyzing whether the GET packet relates to the element packet transmission unit, and allowing the element packet transmission unit to request a specific element from the terminal according to a result of analysis, and c) analyzing a packet header, and allowing the identification packet transmission unit to insert the terminal identification value according to a result of analysis.

The element packet transmission unit that is a section for generating the response packet in response to the GET packet requesting the element of the web page including an image, a client script, CSS, and flash included in the web page uses a transmission method including: a) analyzing the GET packet requesting the element; b) generating the response packet according to a result of analysis of operation a), generating a phrase used to request the element that is an original request target of the corresponding terminal again and a phrase prepared in a language interpretable by a web browser so as to request an element of a specific URL, and inserting the phrases into a response packet body; c) transmitting the response packet to the corresponding terminal; and d) analyzing the packet by using the web browser of the terminal that receives the response packet, and requesting the original request element and the element of the specific URL again.

The terminal determination unit analyzes information managed by the data management unit and determines each terminal in the network environment in which several terminals are used via the single Internet line and a number of available terminals.

The management server for detecting the sharer user inserts terminal identification values in all media that refer to a registry value of an OS referred by a web browser or a cookie value of the OS including a location in which a setting file or other cookie information is stored so as to include the terminal identification value in a HTTP header or packet when the terminal uses Internet to extract and analyze a cookie value of the HTTP header when the terminal connected to Internet accesses Internet, and uses, as insertion and analysis technologies, a first technology of inserting the terminal identification value into the cookie of the terminal and reading and analyzing the terminal identification value as if a site having a specific domain inserts the terminal identification value when the terminal accesses the corresponding site, a second technology of the terminal identification value into the cookie of the terminal and reading and analyzing the terminal identification value as if a non-specific site to which the terminal attempts to access inserts the terminal identification value although a domain is not set and the terminal accesses the corresponding non-specific site, and a third technology of reading and analyzing a cookie inserted by an initial site although the terminal accesses another site if there is the initial site inserts the cookie irrespective of whether the initial site is a specific site or a non-specific site.

According to another aspect of the present invention, there is provided a shared terminal processing method of managing terminals sharing a single Internet line in a network environment in which traffic of all subscribers connected to a wideband network and using Internet is monitored and analyzed, the shared terminal processing method including: detecting sharer users by determining whether to use a sharer through a shared terminal identification system; selecting a shared target by examining an average number of terminals of the detected sharer users during a predetermined period of time; transmitting a three step notice requesting for an additional terminal service subscription to the selected shared target; if the shared target requests for the additional terminal service subscription, receiving an additional terminal service subscription application; and if the shared target rejects the additional terminal service subscription, cutting off Internet with respect to the corresponding shared line.

The selecting of the shared target by examining the average number of terminals of the detected sharer users during the predetermined period of time includes: calculating the average number of terminals during a predetermined past period of time with respect to a recent line available date, establishing a reference policy for selecting the shared target, and selecting a corresponding user as the shared target.

The transmitting of the three step notice requesting for the additional terminal service subscription includes: a first promotion notice operation of notifying an additional shared terminal availability according to a violation of a clause and sending a notice recommending the additional terminal service subscription; a second sanction notice operation of notifying an Internet shutoff date and sending the notice recommending the additional terminal service subscription within a corresponding period; and a third shutoff notice operation of sensing a shutoff guide notice regarding a shared terminal other than a basic subscription line and a basically additional line.

### Advantageous Effects

According to an embodiment of the present invention, an availability status and sharing number of a line can be easily obtained, and an Internet service provider can uniformly provide all subscribers with right to use their own line.

Further, an unauthorized user can be tracked and a web cut-off or charging can be made by generating a database of detected IP information of users, so that, in an economic aspect, charging can be calculated and claimed with respect to an amount of traffic caused by a plurality of hosts of each subscriber, and thus the Internet service provider can cover loss cost due to an ethical use and can provide service subscribers with a right service.

### DESCRIPTION OF THE DRAWINGS

FIG. 1 illustrates an overall configuration of a shared terminal identification system according to an embodiment of the present invention;

FIG. 2 illustrates a configuration of a regional node and a center node of the shared terminal identification system of FIG. 1;

FIG. 3 is a flowchart of a process of performing a terminal authentication method according to an embodiment of the present invention;

FIG. 4 is a flowchart of a process of inserting a terminal identification value in a cookie form into a terminal in a terminal authentication method;

FIG. 5 is a flowchart of a process of reading and analyzing a terminal identification value in a cookie form inserted into a terminal in a terminal authentication method;

FIG. 6 is a flowchart of examples of a process of inserting a terminal identification value in a cookie form into a terminal and a process of reading and analyzing the terminal identification value in the cookie form inserted into the terminal in a terminal authentication method;

FIG. 7 illustrates a schematic configuration of a shared terminal identification system according to another embodiment of the present invention;

FIG. 8 is a table illustrating a terminal management method of a shared terminal identification system;

FIG. 9 illustrates a configuration of a shared terminal identification system that connects and uses a wired/wireless sharer and a hub;

FIGS. 10 and 11 illustrate configurations of a shared terminal identification system that connects and uses VPN equipment including a sharing function;

FIG. 12 illustrates an example of a web shutoff notice screen when an additional line is shut off;

FIG. 13 illustrates an HTTP request message format including a terminal identification value in a cookie form; and

FIG. 14 illustrates an HTTP response message format inserting a terminal identification value in a cookie form into a terminal.

### MODE OF THE INVENTION

The present invention will now be described more fully with reference to the accompanying drawings, in which exemplary embodiments of the invention are shown.

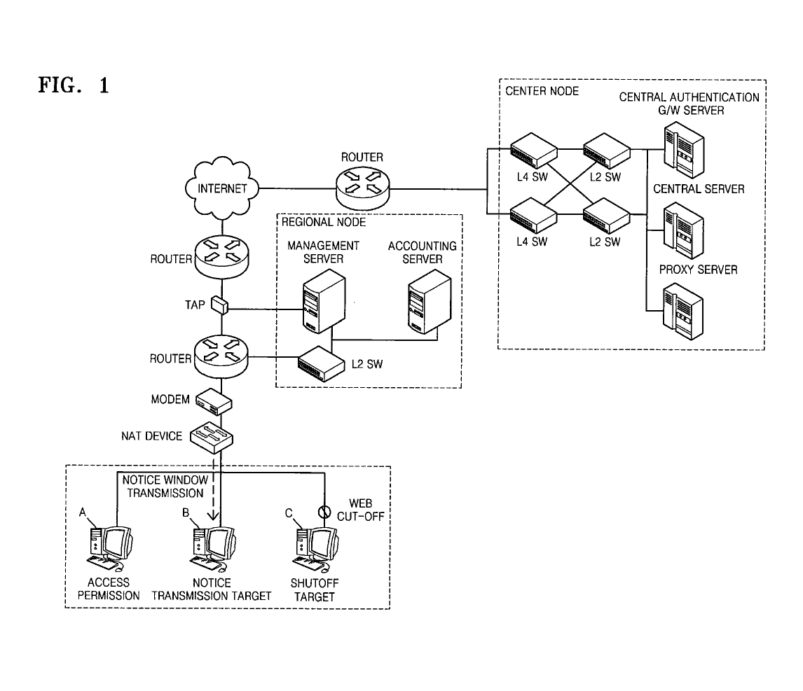

FIG. 1 illustrates an overall configuration of a shared terminal identification system according to an embodiment of the present invention.

Referring to FIG. 1, the shared terminal identification system of the present invention may include regional nodes for analyzing traffic at locations where the overall traffic of Internet subscribers can be monitored and a center node that manages and controls each of the regional nodes formed several locations over a network. The regional nodes include a management server, an accounting server, and a switch L2. The center node includes switches L4 and L2, a central authentication G/W server, a central server, and a proxy server, and may further include storage, a management console standby server. The number of management servers may be one or more according to an amount of traffic generated by Internet subscribers of a corresponding region, and thus the shared terminal identification system of the present invention is not limited thereto.

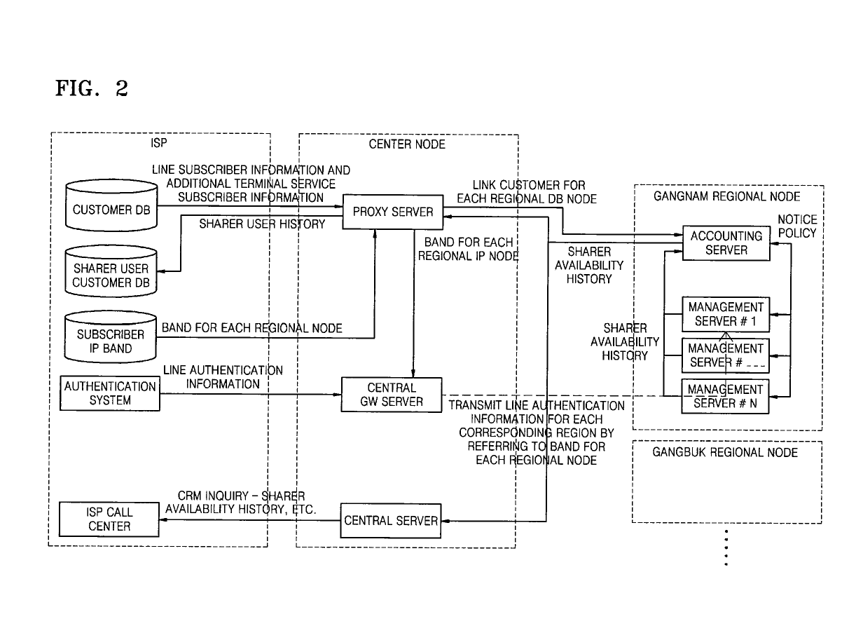

FIG. 2 illustrates a configuration of a regional node and a center node of the shared terminal identification system of FIG. 1, in which a configuration of each server with respect to each node is shown.

Regarding configurations of servers shown in FIGS. 1 and 2, the regional node refers to one of units divided from a whole region such that a company selling an Internet line to subscribers, such as an Internet service provider (ISP), a multiple system operator (MSO), and a system operator (SO), can accommodate traffic of all subscribers. For example, a Gangnam node accommodating traffic of subscribers resident in regions of Yeoksam-dong, Samsung-dong, and Yangjae-dong may be designated as a single regional node.

A proxy server receives Internet subscriber information, i.e., customer information DB and a subscriber IP band for each regional node, from an ISP, receives a history of each Internet subscriber, such as an Internet line subscription, an Internet line termination, an additional terminal service subscription, and an additional terminal service termination in real time, and transfers sharer user history information collected from a charging server to the ISP.

A central authentication G/W server receives authentication information of Internet subscribers in connection with an authentication system of the ISP, and transmits the authentication information to a management server of each regional node. A central server manages a sharer user customer DB based on the sharer user history information collected from an accounting server, provides a CRM page to the ISP, selects a sharing target, i.e. a notice transmission target, and establishes a notice policy.

The accounting server receives the customer DB of Internet subscribers managed by a corresponding regional node from the proxy server, updates a regional node customer DB, collects the notice policy from the central server, and collects the sharer user history information from a management server.

The management server collects the authentication information of Internet subscribers from the central authentication G/W server, collects the notice policy from the accounting server, monitors and analyzes the traffic of subscribers, detects a sharer user, transmits a notice to the sharer user based on the notice policy collected from the accounting server, and transmits history information of the detected sharer user to the accounting server.

In this regard, the notice policy is a policy regarding the notice transmission concerning a subscriber determined as the sharer user, includes information regarding how many times and what notice will be transmitted to which subscriber during a specific period of time. The authentication information is information for identifying a subscriber causing traffic, includes an Internet subscription ID and an IP address, and may match a traffic IP and an authentication information IP when monitoring the traffic and determine an ID of the subscriber.

In addition, the CRM page is mainly used to ask an ISP customer center about related content after the sharer user acknowledges a notice transmitted from an additional terminal system, inquires of the ID of the subscriber, and confirms information regarding the sharer availability history, such as a daily sharer availability status regarding the corresponding subscriber, a recent average terminal number, a maximum terminal number, and a current notice transmission target. The subscriber IP bandwidth for each regional node is information regarding an available IP bandwidth of all Internet subscribers for each region, identifies a management server of which region to which the corresponding authentication information is transmitted when line authentication information is received from an authentication system of the ISP, and transmits the authentication information to the management server of the identified region.

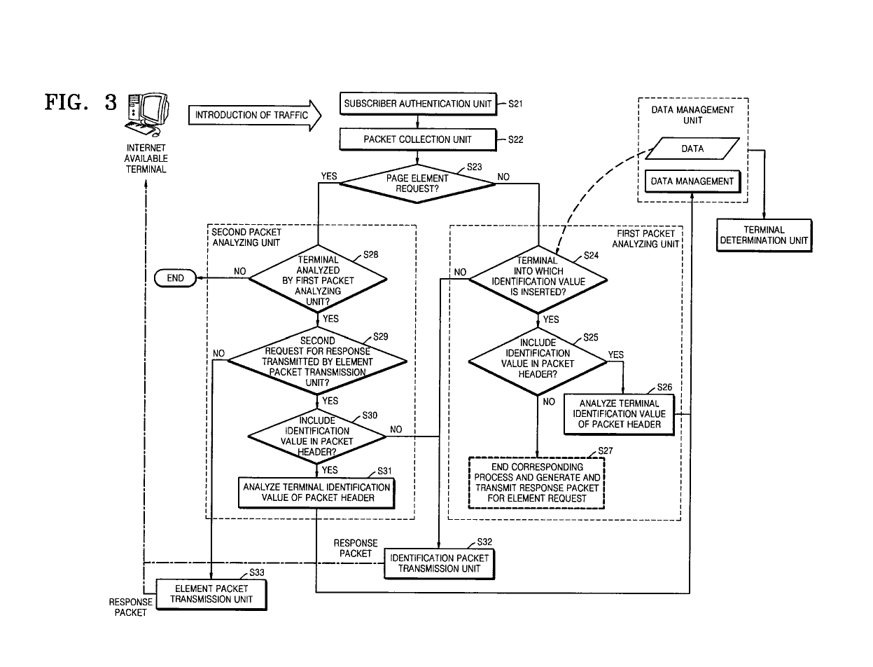

FIG. 3 is a flowchart of a process of performing a terminal authentication method according to an embodiment of the present invention, to identify users in a sharer or an NAT and determine the number of shared terminals.

Referring to FIG. 3, a subscriber is identified by checking an Internet subscription ID that is available through a subscriber line authentication, i.e. a subscriber line authentication unit, regarding a corresponding terminal by mirroring traffic of a terminal that uses Internet (operation S21), and GET packets are collected from packets collected by a packet collection unit (operation S22).

A first packet analyzing unit or a second packet analyzing unit is selected according to packet types by analyzing the collected GET packets and checking whether there is a request of a page element in the GET packets (operation S23). In this regard, the page element refers to an element recognized by a user by constituting a web page including an image, a client script, a cascading style sheet (CSS), and flash.

The first packet analyzing unit is a section for analyzing a header of a GET packet requesting the web page. Regarding the collected GET packet, the first packet analyzing unit compares and analyzes authentication information of the subscriber line authentication unit and data managed by a data management unit, determines whether a corresponding terminal is a terminal already managed by the data management unit, i.e. a terminal into which a terminal identification value is previously inserted, if the corresponding terminal is a terminal into which the terminal identification value is not inserted, allows an identification packet transmission unit to insert the terminal identification value into the corresponding terminal, and, if the corresponding terminal is the terminal into which the terminal identification value is inserted, proceeds to an operation of analyzing the terminal identification value (operation S24). If the corresponding terminal includes the terminal identification value by extracting headers of the collected GET packets collected by the packet collection unit, the data managed by the data management unit is updated by analyzing the terminal identification value, if the corresponding terminal does not include the terminal identification value, the corresponding operation is performed no longer, and the request for an element of the web page regarding the corresponding terminal is processed in the second packet analyzing unit (operations S25, S26, and S27).

The second packet analyzing unit is a section for analyzing a GET packet requesting the element of the web page, determines whether a terminal corresponding GET packet is analyzed by the first packet analyzing unit, if the terminal is not analyzed by the first packet analyzing unit, terminates the process (operation S28), if the terminal is analyzed by the first packet analyzing unit, analyzes whether the corresponding GET packet is a packet transmitted by an element packet transmission unit, if the corresponding GET packet is not a packet transmitted by the element packet transmission unit, allows the element packet transmission unit to request an element of a specific URL (operation S29), if the corresponding GET packet is a packet transmitted by the element packet transmission unit, analyzes an identification value by extracting a packet header, if the packet header includes the identification value, updates the data managed by the data management unit, and if the packet header does not include the identification value, allows an identification packet transmission unit to insert the terminal identification value into the corresponding terminal (operations S30 and S31).

The identification packet transmission unit generates and transmits a response packet in response to a request packet so as to insert the terminal identification value in a cookie form into the terminal, and stores information regarding the terminal and the terminal identification value inserted into the terminal to allow the data management unit to manage the terminal (operation S32).

The element packet transmission unit generates and transmits the response packet including a phrase used to request an element of a specific domain (a URL or an IP) so as to read a terminal identification value accessible only in the specific domain after being inserted into cookie storage of the terminal by the identification packet transmission unit (operation S33).

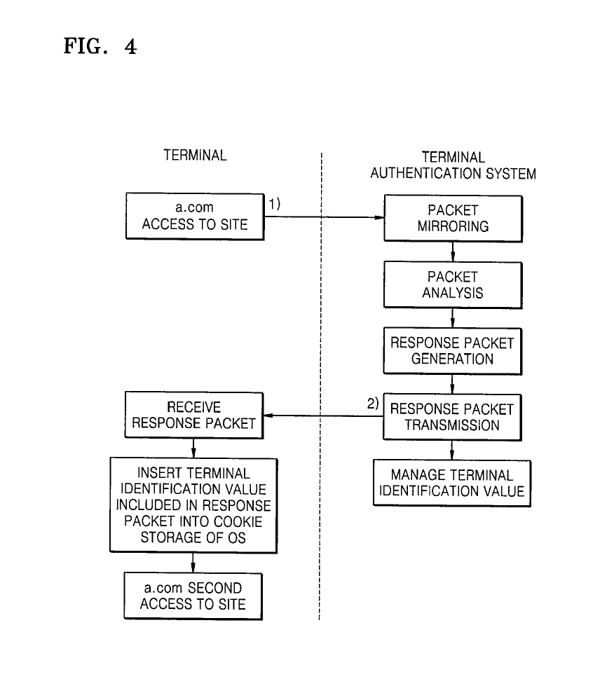

FIG. 4 is a flowchart of a process of inserting a terminal identification value in a cookie form into a terminal in a terminal authentication method, to insert the terminal identification value into the corresponding terminal performed by each analyzing unit and transmission unit.

Referring to FIG. 4, when a request for an access to a specific site takes place, a terminal authentication system mirrors and analyzes a corresponding packet, generates and transmits a response packet into which the terminal identification value is inserted, allows information regarding the terminal identification value of the corresponding terminal to be stored and managed by a management unit, and transmits the response packet to the terminal, and thus the corresponding terminal inserts the terminal identification value included in the response packet in cookie storage of an OS.

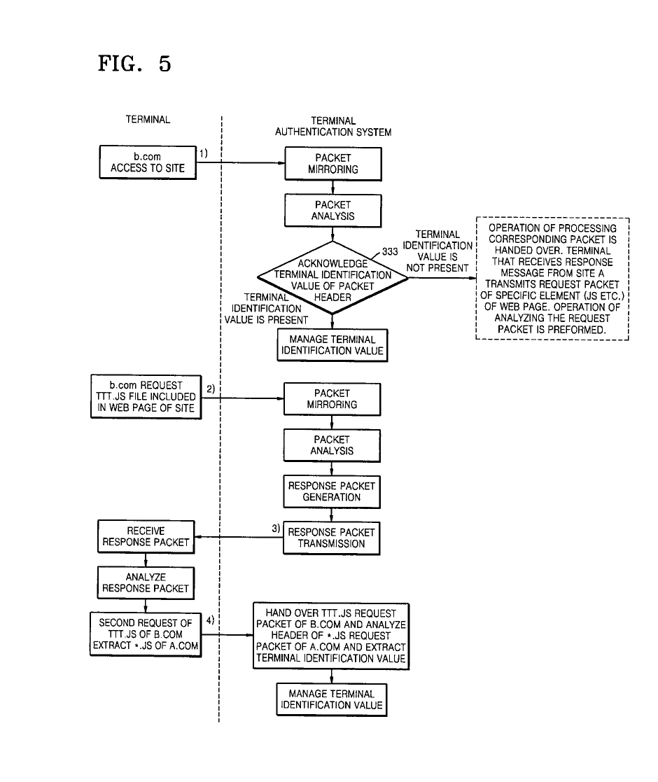

FIG. 5 is a flowchart of a process of reading and analyzing a terminal identification value in a cookie form inserted into a terminal in a terminal authentication method, to extract the terminal identification value inserted into the terminal.

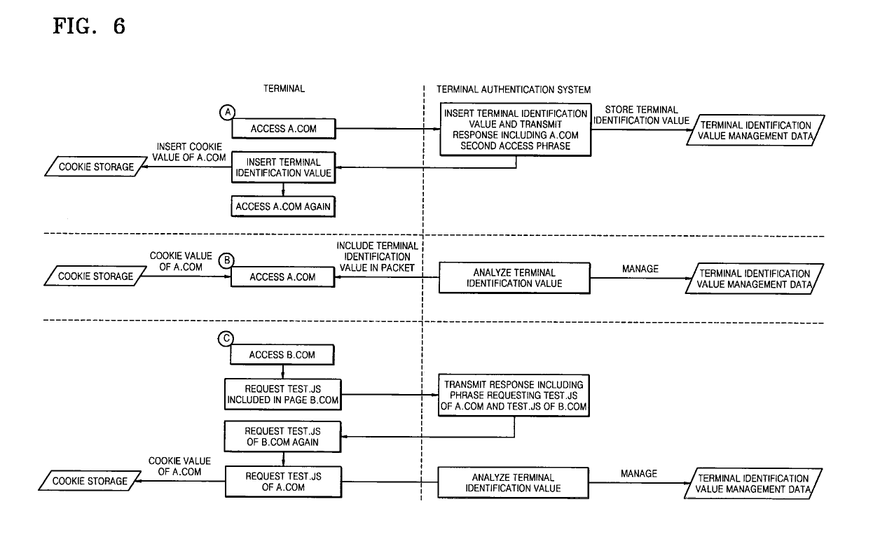

FIG. 6 is a flowchart of examples of a terminal authentication method. (A) is a process of inserting a terminal identification value accessible only in A.com into cookie storage of a terminal when the terminal accesses A.com. (B) is a process of reading and analyzing the terminal identification value when the same terminal accesses A.com again. (C) is a process of reading the terminal identification value accessible in A.com when the same terminal accesses B.com.

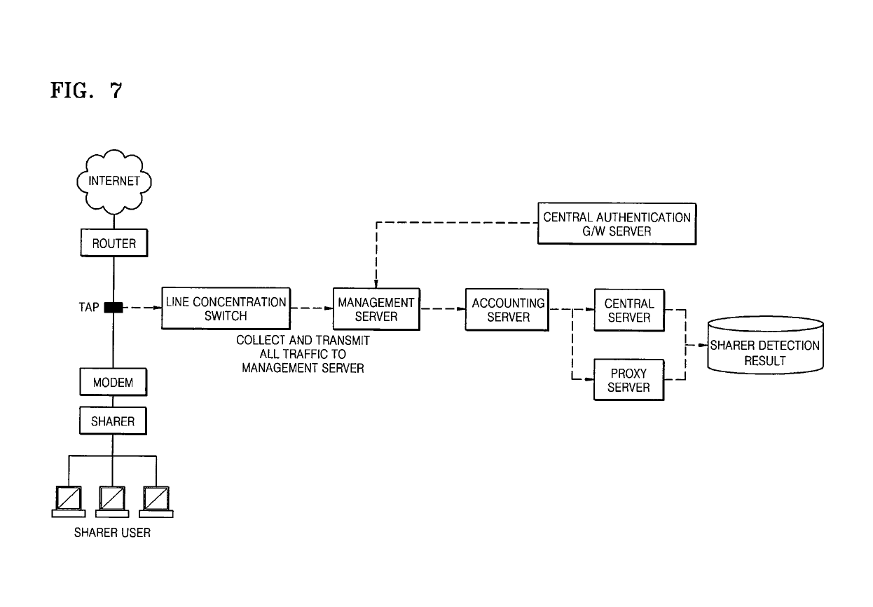

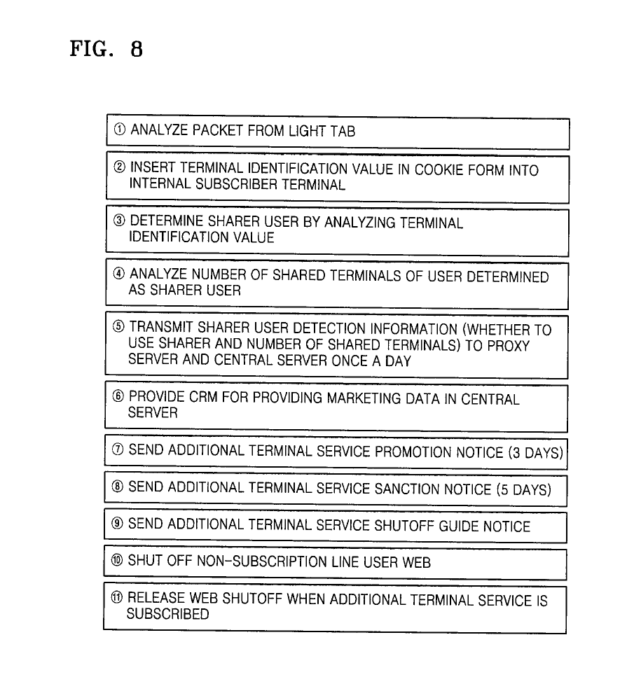

FIG. 7 illustrates a schematic configuration of a shared terminal identification system according to another embodiment of the present invention. The shared terminal identification system collects traffic by adding a tap and a line concentration switch to an Internet connection line connecting a user and a sharer. FIG. 8 is a table illustrating a process of detecting a sharer and processing a service on an additional terminal according to the configuration of the shared terminal identification system of FIG. 7.

Upon comparing the configuration of FIG. 7 and the process of FIG. 8, the concentration switch is added to the Internet line connected to a wideband network according to a network environment and an amount of available traffic of an Internet subscriber terminal, and collects whole traffic from a traffic mirroring device such as, a light tap, a UTP tap, and transmits the collected traffic to a management server. The concentration switch is added. The management server authenticates each terminal by analyzing all packets received from the line concentration switch and inserting a terminal identification value in a cookie form with respect to Internet subscribers and transmits corresponding information to an accounting server. The accounting server determines a sharer user based on the received information regarding the terminal identification value and detects an accurate number of sharing terminals.

The management server analyzes HTTP GET packets of all terminals connected to Internet, generates a response packet into which the terminal identification value in the cookie form is inserted, and transmits the response packet to the corresponding terminal, and thus each terminal is authenticated by using the terminal identification value inserted into the terminal, and sharer user information such as whether to use a sharer is confirmed by analyzing data.

The above information is used to generate and manage user IP information as a database in which an IP system is established in a network using an NAT configuration, a firewall, and an ISP network.

The accounting server performs a sharer user determination function, a shared terminal number detection function, a function of transmitting the sharer user information to a central server and a proxy server, an IP sharer service promotion notice sending function, an IP sharer service sanction notice sending function, an IP sharer service cut-off notice sending function, a non-subscription line user web cut-off function, and a web cut-off removal function when an IP sharer service is subscribed.

In addition, the accounting server transmits sharer user detection information to the central server and the proxy server periodically, for example, once a day, stores accounting information relating to an amount of transmitted packets, a total amount of available traffic, and a number of shared terminals, and performs an accounting operation based on the accounting information. If a corresponding shared terminal removes an Internet connection, the accounting server may additionally perform an accounting ending function.

In FIG. 7, the central server and the proxy server separately generate IP sharer detection results as a database and store the database in a DB server. The central server uses the stored database to provide a CRM. The proxy server uses the stored database to connect a sharer detection history.

FIG. 8 is a table illustrating an example of a terminal management method of a shared terminal identification system. The terminal management method analyzes a packet by mirroring traffic of the wideband network from the tap, inserts the terminal identification value in a cookie form into the Internet subscriber terminal, determines a sharer user by analyzing the terminal identification value, analyzes a shared terminal number of a user determined as the sharer user, transmits the sharer user detection information such as whether to use the sharer and the shared terminal number to the proxy server and the central server once a day, provides a CRM for providing data to the central server, sends an additional terminal service promotion and subscription guide notice, a sanction guide notice, and a shutoff guide notice, shuts off a web of a non-subscription line user, and removes the web shutoff if the corresponding user subscribes the additional terminal service.

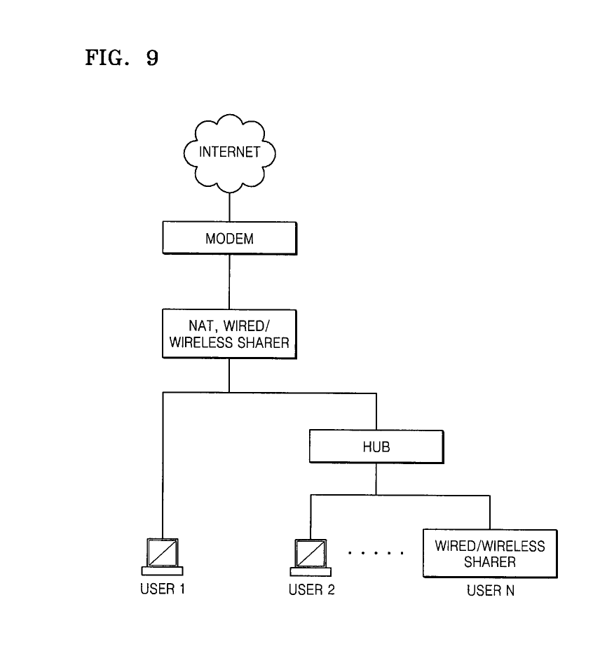

FIG. 9 illustrates a configuration of a shared terminal identification system that connects and uses a wired/wireless sharer and a hub. A method of connecting the wired/wireless sharer and the hub uses a general sharer by which a plurality of users access Internet through the wired/wireless sharer. The sharer can be detected and a number of additional terminals can be acknowledged.

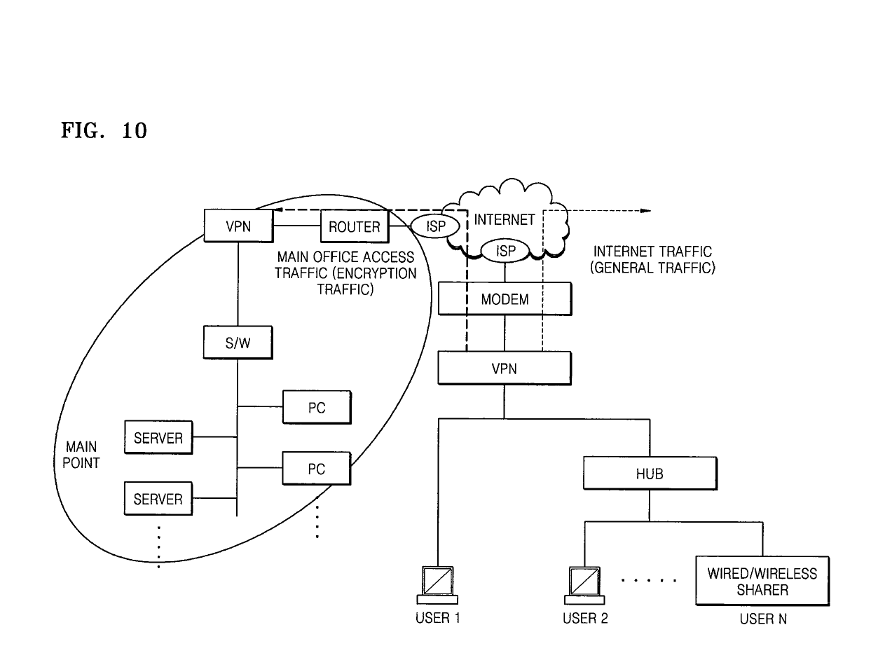

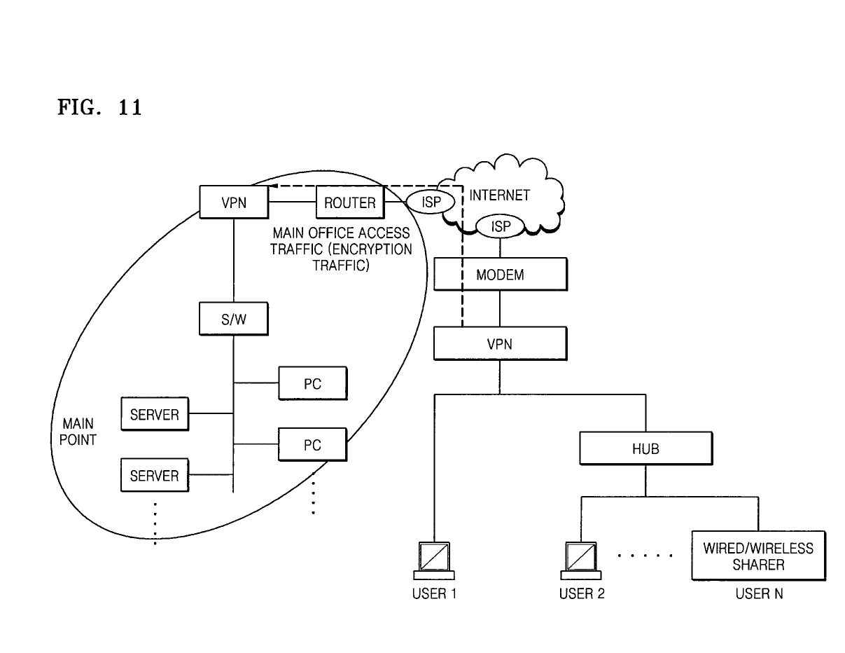

FIGS. 10 and 11 illustrate configurations of a shared terminal identification system that connects and uses VPN equipment including a sharing function.

Referring to FIG. 10, in a method of connecting via the VPN equipment including the sharing function, connection traffic to the center using the VPN equipment is accessed as encrypted traffic through the VPN equipment, general Internet traffic is directly accessed to Internet through a modem, thereby detecting whether to use the VPN equipment.

The method of using VPN dedicated equipment connects the encrypted traffic from a region to the center as shown in FIG. 11. The Internet traffic uses Internet at an Internet available point through the center connection traffic after passing through an encryption section, and whether to use the VPN equipment can be partially detected for each VPN equipment.

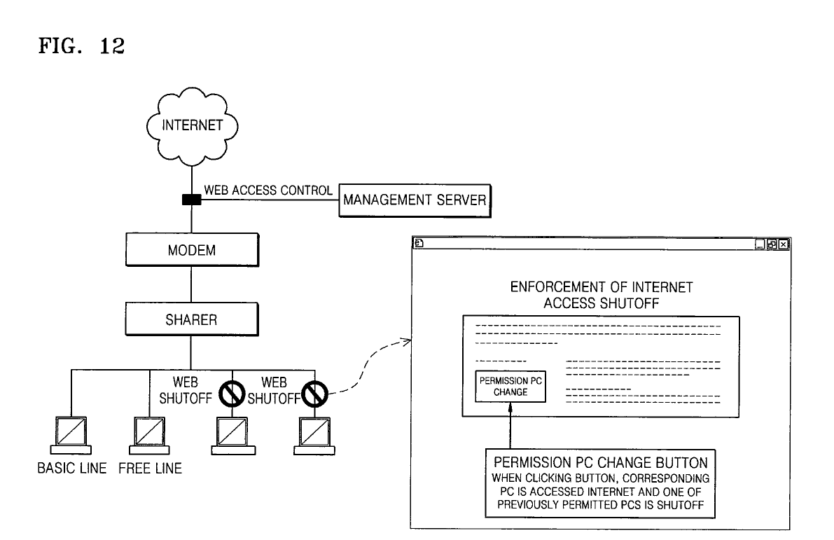

FIG. 12 illustrates an example of a web cut-off notice screen when an additional line is cut off. As described with reference to FIG. 8, a central server provides a CRM for providing marketing data, sends an additional terminal service promotion and subscription guide notice, a sanction guide notice, and a cut-off guide notice, when a web of a non-subscription line user is cut off and when a corresponding user wants to subscribe an additional terminal service, receives a subscription request through a corresponding notice web page, and removes Internet connection cut-off if a subscription process is complete.

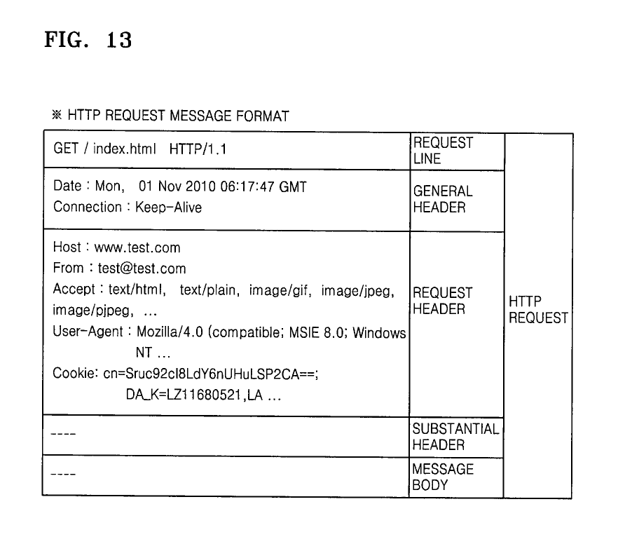

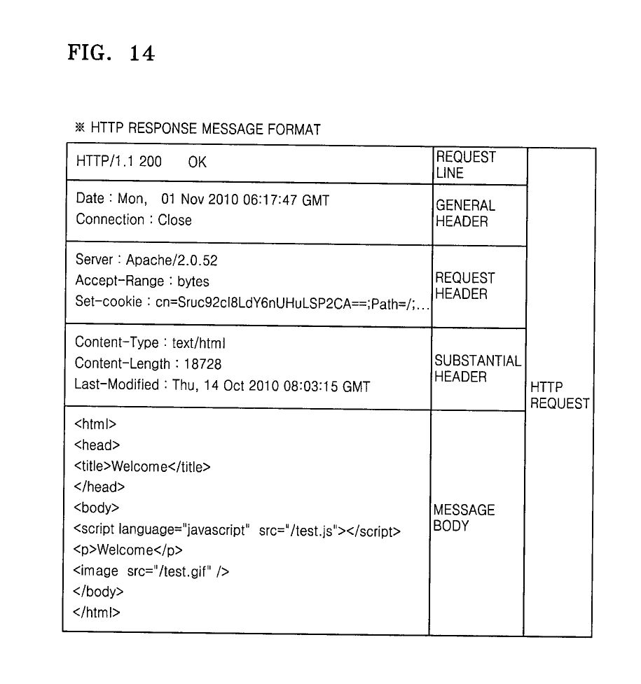

FIG. 13 illustrates an HTTP request message format including a terminal identification value in a cookie form. FIG. 14 illustrates an HTTP response message format inserting a terminal identification value in a cookie form into a terminal. Referring to FIGS. 13 and 14, if a terminal user requests a web access to a specific site, a stored cookie value is read from corresponding traffic through the HTTP request message, and, if the terminal does not include the terminal identification value, the terminal identification value in the cookie form is generated and inserted into the terminal.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A shared terminal identification system for identifying and managing terminals sharing a single Internet line in a network environment in which traffic of all subscribers connected to a wideband network and using Internet is monitored and analyzed, the shared terminal identification system comprising:
a management server for analyzing the traffic of the subscribers and detecting sharer users;
an accounting server for identifying the sharer users and determining a number of terminals using a sharer;
a central server for providing marketing data;
a central authentication G/W server for managing and linking to authentication information; and
a proxy server for managing and linking to a customer DB,
wherein the management server for detecting the sharer user comprises:
a subscriber line authentication unit for identifying all subscribers using Internet;
a packet collection unit for detecting an HTTP GET packet;
a first packet analyzing unit for analyzing a header of the HTTP GET packet requesting a web page;
an identification packet transmission unit for generating and transmitting a response packet in response to the HTTP GET packet requesting the web page so as to insert an identification value into the terminal;
a second packet analyzing unit for analyzing a GET packet requesting an element of the web page;
an element packet transmission unit for generating and transmitting a response packet in response to the GET packet requesting the element of the web page so as to request a specific element;
a data management unit for managing subscriber authentication data and the entire data including an IP and URL and the terminal identification value so as to analyze, identify, and manage terminals; and
a terminal determination unit for determining the terminals used by connecting several terminals to the single line and a number of the terminals.

2. The shared terminal identification system of claim 1, wherein the subscriber line authentication unit collects and manages IP-ID, IP-Mac, and IP-CMMAc in the central authentication G/W server by linking to a unified authentication system that manages IP-ID and IP-Mac information indicating a person of a corresponding IP in real time with respect to a network subscriber of an authentication section, collects and manages IP-Mac and Port-Mac in an equipment name-Mac format in the central authentication G/W server by periodically collecting IP-Mac and Port-Mac managed by specific equipment such as a router, a switch, L3, L2, and a DHCP to use IP-Mac and Port-Mac as authentication data with respect to a network subscriber of a non-authentication section, classifies the authentication data stored in the authentication G/W server into IP bandwidths, identifies the authentication data in an environment in which traffic of a specific terminal is mirrored to the management server in which a corresponding backbone network is installed, and transmits the authentication data to an authentication processing engine of the corresponding management server, manages the received authentication data in memory managed by the authentication processing engine of the corresponding management server in real time, when the corresponding traffic comes in, prepares to respond to the authentication data in real time, analyzes a user packet of the mirrored traffic, extracts an IP, and authenticates the IP in real time by utilizing the authentication data of the authentication processing engine of the corresponding management server.

3. The shared terminal identification system of claim 1, wherein the packet collection unit collects the GET packet necessary for analysis from among the monitored entire traffic.

4. The shared terminal identification system of claim 1, wherein the first packet analyzing unit that is a section for analyzing the header of the HTTP GET packet requesting the web page a) compares and analyzes authentication information of the subscriber line authentication unit regarding the collected GET packets and data managed by the data management unit, determines whether a corresponding terminal is a terminal into which the terminal identification value is previously inserted, and allows the identification packet transmission unit to insert the terminal identification value into the corresponding terminal according to a result of determination, and b) extracts headers of the collected GET packets collected by the packet collection unit, analyzes the terminal identification value, ends the processing operation according to a result of analysis, and allows the second packet analyzing unit for analyzing the GET packet to process a request for the element of the web page requested by the terminal.

5. The shared terminal identification system of claim 1, wherein the identification packet transmission unit that is a section for generating and transmitting the response packet in response to the HTTP GET packet so as to insert the identification value into the terminal uses a transmission method comprising:
a) inserting the terminal identification value into a cookie of a packet header to be generated and inserting a phrase generated in a client script and HTML interpretable by a web browser into a packet body to cause the corresponding terminal to be requested again to a designation address (destination IP or URL) that is an original request target;
b), unlike operation a), inserting a phrase generated by a language interpretable by the web browser into the packet body so as to call a URL of the generated web page to cause the terminal identification value to be inserted into the cookie by a client script or a server script;
c) transmitting a response packet generated through operation a) or b) to the corresponding terminal;
d) adding authentication information regarding the corresponding terminal and information for managing the terminal identification value to the data managed by the data management unit so as to manage the corresponding terminal; and
e) analyzing the packet by using the web browser of the terminal that receives the response packet, inserting the terminal identification value into a location in which cookie information of an OS referred to by the web browser is stored, requesting a web page for a server that is an original request target again or after accessing the URL of the generated web page of operation b), inserting the terminal identification value into the cookie.

6. The shared terminal identification system of claim 1, wherein the data management unit manages the authentication data, IP and URL information regarding an original request destination server or a specific web page address, and the terminal identification value in a single set.

7. The shared terminal identification system of claim 1, wherein the second packet analyzing unit that is a section for analyzing the GET packet requesting the element of the web page a) analyzes whether the corresponding terminal is the terminal analyzed by the first packet analyzing unit, b) analyzing whether the GET packet relates to the element packet transmission unit, and allowing the element packet transmission unit to request a specific element from the terminal according to a result of analysis, and c) analyzing a packet header, and allowing the identification packet transmission unit to insert the terminal identification value according to a result of analysis.

8. The shared terminal identification system of claim 1, wherein the element packet transmission unit that is a section for generating the response packet in response to the GET packet requesting the element of the web page including an image, a client script, CSS, and flash included in the web page uses a transmission method comprising:
a) analyzing the GET packet requesting the element;
b) generating the response packet according to a result of analysis of operation a), generating a phrase used to request the element that is an original request target of the corresponding terminal again and a phrase prepared in a language interpretable by a web browser so as to request an element of a specific URL, and inserting the phrases into a response packet body;
c) transmitting the response packet to the corresponding terminal; and
d) analyzing the packet by using the web browser of the terminal that receives the response packet, and requesting the original request element and the element of the specific URL again.

9. The shared terminal identification system of claim 1, wherein the terminal determination unit analyzes information managed by the data management unit and determines each terminal in the network environment in which several terminals are used via the single Internet line and a number of available terminals.

10. The shared terminal identification system of claim 1, wherein the management server for detecting the sharer user inserts terminal identification values in all media that refer to a registry value of an OS referred by a web browser or a cookie value of the OS including a location in which a setting file or other cookie information is stored so as to include the terminal identification value in a HTTP header or packet when the terminal uses Internet to extract and analyze a cookie value of the HTTP header when the terminal connected to Internet accesses Internet, and uses, as insertion and analysis technologies, a first technology of inserting the terminal identification value into the cookie of the terminal and reading and analyzing the terminal identification value as if a site having a specific domain inserts the terminal identification value when the terminal accesses the corresponding site, a second technology of the terminal identification value into the cookie of the terminal and reading and analyzing the terminal identification value as if a non-specific site to which the terminal attempts to access inserts the terminal identification value although a domain is not set and the terminal accesses the corresponding non-specific site, and a third technology of reading and analyzing a cookie inserted by an initial site although the terminal accesses another site if there is the initial site inserts the cookie irrespective of whether the initial site is a specific site or a non-specific site.

11. The shared terminal identification system of claim 1, wherein the management server and the charging server consist of regional nodes for analyzing traffic,
wherein the central server, the central authentication G/W server, and the proxy server consist of a center node for managing and controlling the regional nodes disposed in several locations over a network, and
wherein the management server consists of one or more management servers according to an amount of traffic generated by Internet subscribers of a corresponding region.

12. The shared terminal identification system of claim 1, wherein the proxy server receives Internet subscriber information, i.e. a customer information DB and a subscriber IP band for each regional node from the ISP, receives a history of each subscriber, such as an Internet line subscription, an Internet line termination, an additional terminal service subscription, and an additional terminal service termination in real time, and transfers sharer user history information collected from the charging server to the ISP,
wherein the central authentication G/W server receives authentication information of Internet subscribers in connection with an authentication system of the ISP, and transmits the authentication information to a management server of each regional node,
wherein the central server manages a sharer user customer DB based on the sharer user history information collected from the charging server, provides a CRM page to the ISP, selects a sharing target, i.e. a notice transmission target, and establishes a notice policy, and
wherein the charging server collects the authentication information of Internet subscribers from the central authentication G/W server, collects the notice policy from the central server, monitors and analyzes the traffic of subscribers, detects a sharer user, transmits a notice to the sharer user based on the notice policy collected from the charging server, and transmits history information of the detected sharer user to the charging server.

13. A shared terminal processing method of managing terminals sharing a single Internet line in a network environment in which traffic of all subscribers connected to a wideband network and using Internet is monitored and analyzed, the shared terminal processing method comprising:
detecting sharer users by determining whether to use a sharer through a shared terminal identification system;
selecting a shared target by examining an average number of terminals of the detected sharer users during a predetermined period of time;
transmitting a three step notice requesting for an additional terminal service subscription to the selected shared target;
if the shared target requests for the additional terminal service subscription, receiving an additional terminal service subscription application; and
if the shared target rejects the additional terminal service subscription, cutting off Internet with respect to the corresponding shared line.

14. The shared terminal processing method of claim 13, wherein the selecting of the shared target by examining the average number of terminals of the detected sharer users during the predetermined period of time comprises: calculating the average number of terminals during a predetermined past period of time with respect to a recent line available date, establishing a reference policy for selecting the shared target, and selecting a corresponding user as the shared target.

15. The shared terminal processing method of claim 13, wherein the transmitting of the three step notice requesting for the additional terminal service subscription comprises:
a first promotion notice operation of notifying an additional shared terminal availability according to a violation of a clause and sending a notice recommending the additional terminal service subscription;
a second sanction notice operation of notifying an Internet shutoff date and sending the notice recommending the additional terminal service subscription within a corresponding period; and
a third shutoff notice operation of sensing a shutoff guide notice regarding a shared terminal other than a basic subscription line and a basically additional line.
